(19) United States
(12) Patent Application Publication
(10) Pub. No.: US 2018/0139157 A1
(43) Pub. Date: May 17, 2018

(54) COMPUTER-IMPLEMENTED SYSTEM AND METHOD FOR CREATING, STORING AND SHARING CROPPED MULTIMEDIA CONTENT DEVOID OF VISUAL BACKGROUND INFORMATION

(71) Applicant: Bervick Deculus, Los Angeles, CA (US)

(72) Inventor: Bervick Deculus, Los Angeles, CA (US)

(73) Assignee: Intelmate LLC, San Francisco, CA (US)

(21) Appl. No.: 15/355,038

(22) Filed: Nov. 17, 2016

(51) Int. Cl. H04L 12/58; G06F 17/30; G06Q 30/06; H04M 1/725

(52) U.S. Cl. CPC H04L 51/063; G06F 17/30858; G06F 3/0482; G06Q 30/0641; H04M 1/72555; G06Q 30/0633

(57) ABSTRACT

Disclosed is a computer-implemented system for creating, storing and sharing cropped videos of real world subjects (i.e., headshots or talking heads), each of which comprising a cropped video exclusive of background. The system comprises a camera module for activating a camera and a boundary module for overlaying a boundary marker over the camera feed, the boundary marker configured to be aligned with the boundaries of the head wherein, the boundary marker stays with the real world subject (i.e., headshot) throughout the movements thereof as reflected in the camera feed, a portion or the entirety of which is recorded, a crop module for cropping the video so as to retain the desired portion (i.e., user's head) of the video information as defined by the boundary marker resulting in the generation of a cropped video (i.e., headshot) and a sharing module disposed in operative communication with one or more communication applications so as to enable the sharing of the cropped video (i.e., headshot or talking head) therefrom.

### BACKGROUND

The present disclosure relates to computer-implemented systems and methods for creating novel sharable multimedia content and more particularly, relates to a computer-implemented system and method for creating, storing and sharing cropped multimedia content devoid of visual background information.

In today's internet-era, as texting is to electronic communication, pictograms are to texting. In other words, pictograms, such as, emoticons, emojis, ideograms, etc., are an integral part of texting. Initially (and even today to a degree) emoticons—i.e., the typographic representations of human facial expressions—were employed in text messaging. Seeing the proliferation of the usage thereof and recognizing the communication needs of users, emojis were introduced and permanently incorporated into virtual keyboards, which are part of almost all touchscreen devices. Emojis, among other things, are cartoon-like faces or smiley faces, which are pictorial representations of the human facial expressions. Emojis, compared to emoticons, accommodate a broader array of human emotions as they are pictures specifically created for conveying human expressions, emotions, sentiments, etc. Today, emojis have evolved into animated emojis such as, a winking face, crying face, etc. In spite of all this advancement, the emojis still cannot capture the complexity of human emotions, convey a custom message, and lastly, can never be a good representation of a user.

In the light of the aforementioned discussion, there is a need in the art for a solution that addresses the various shortcomings of emojis.

### SUMMARY

An embodiment of the present invention is a computer-implemented system for creating, storing and sharing cropped multimedia content devoid of visual background information. More particularly, the cropped multimedia content refers to, yet not limited to one or more headshot videos, each of which comprises a video of the head of a human subject without background. Headshot or talking head videos may become the inaugural manifestation, but the present invention does not hinge on human headshots and/or talking head videos as other real world subjects may be preferred choices (i.e., birthday cake, exotic car, full human body, high heel shoes). The headshot video is preferably a short video, the duration of which ranges from 5 to 7 seconds. The cropped video (i.e., talking head) may or may not be accompanied by sound, as at times, the video could just be a video conveying one or more facial expressions of the human subject therein. In a way, a headshot video could be seen as a personalized emoji with the face of the user (i.e., the human subject) featured in the headshot video communicating a personal message. The system thus addresses the shortcomings of the prior art by employing the very face of the user as the short video of the user is the ultimate and perfect representation of the user. The system has one or more Instant Messaging (IM) or texting computer applications (apps) playing a part in the sharing of the headshot videos between two or more user terminals running at least one common IM app. The IM apps may comprise commonplace third-party IM apps such as Whatsapp, Viber, Skype, etc., or maybe be a native or proprietary IM app built into the operating system running on the user terminal. Outside of users utilizing third-party commonplace IM apps, MMS and SMS text messaging are default selections for users to connect and communicate with intended recipients.

The system of the present invention comprises a user interface for enabling a user to interact therewith, a system processor, for ease of understanding, divided into a plurality of processing modules, and a library for storing headshot videos. The user interface is facilitated by a user terminal, which may comprise a smartphone, a tablet PC, a laptop PC, a desktop PC, etc., which has a video camera preferably built thereinto.

The processing modules comprise a camera module, a boundary module, a crop module and a sharing module. The camera module is disposed in operative communication with the camera onboard the user terminal. The camera module, upon express user command, actuates the camera resulting in the display of the camera feed on the user terminal wherein, the camera feed features the head of the human and/or real world subjects. The boundary module comprises a boundary marker overlaid on the camera feed. The boundary marker comprises a closed curved outline, which is configured to be adjustable and movable until the boundary marker is aligned with the boundaries of the head of the human and/or real world subject. Once the boundary marker is set to user's satisfaction, the user may proceed to record a video resulting in the generation of an input video. Notably, once the boundary marker is set, the boundary marker stays with the head through the various movements thereof during the recording.

Actuating an exemplary “Crop” button provided by the crop module resulting in saving the portion of the input video within the boundary marker (i.e., the head of the human subject) and omitting the rest of the video (i.e., the background) lying outside of the boundary marker. This results in the generation of a headshot video, which is stored within the library. The sharing module, as mentioned earlier, establishes an operative communication between one or more IM app servers and the system. As a result of the operative communication between the system and the IM app servers, the headshot videos stored within the library can be shared between two or more user terminals running at least one common IM app.

In order to share a headshot video with a fellow user and/or non-user (having a user terminal running a common IM app or generic SMS/MMS messaging app), the user simply selects the IM app or text messaging icon. Once in the IM app, selecting an exemplary “Attach” icon opens up an interface, which allows access to all the headshot videos user-generated and downloaded stored within the library. The user may proceed to select one or more headshot videos, which then, upon inputting the recipient or recipients, are dispatched to the user terminal of the recipient(s).

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present invention, is a schematic block diagram of the computer-implemented system and accompanying elements.

FIG. 2A User's finger selects the video stop command.

FIG. 2B User's finger selects the preview command.

FIG. 2C User's finger selects command to save boundary settings.

FIG. 3, according to an embodiment of the present invention, is a schematic block diagram of the store of the system and accompanying elements.

FIG. 4, according to an embodiment of the present invention, is a screenshot depicting the store.

FIG. 5A User's finger selects the option to text his talking head video.

FIG. 5B User's finger selects the command to attach media with or without a compose text.

FIG. 5C User's finger selects the most recent recorded talking head video to complete attachment.

FIG. 5D User's finger selects the send command.

FIG. 6A User's finger presses and holds for additional selections from keyboard menu.

FIG. 6B User's finger selects the most recent talking head video from the keyboard menu.

FIG. 6C User's finger selects the send command.

FIG. 7, according to an alternate embodiment of the present invention, is a schematic block diagram of the computer-implemented system and accompanying elements.

FIG. 8A User's finger selects the video record command.

FIG. 8B A user interaction experience to size the template boundary to fit around his head.

FIG. 8C User's finger selects the crop command.

FIG. 8D User's finger selects the play command.

FIG. 8E Prior to the share most recent head video for storing purposes.

FIG. 8F User presses a setting command to hide or unhide media for storing purposes.

FIG. 9, according to an embodiment of the present invention, is a flowchart depicting the process of the creating, storing and sharing a headshot video.

FIG. 10, according to an embodiment of the present invention, is a flowchart depicting the process of purchasing a paid headshot video from the store.

FIG. 11, according to an alternative embodiment of the present invention, is a flowchart depicting the process of the creating, storing and sharing a headshot video.

The various aspects of the present disclosure mentioned above are described in further detail with reference to the aforementioned figures and the following detailed description of exemplary embodiments.

### FIGURES—REFERENCE NUMERALS

10—System
12—User Interface
14—System Processor
16—Communications Network
18—User Terminal
20—Library
22—Camera Module
24—Boundary Module
26—Crop Module
28—Sharing Module
30—IM App Server
32—Headshot Video
34—Head
36—Background
38—Boundary Marker
40—Store
42—Database
44—Store Processor
46—Cart Module
48—Checkout Module
50—Payment Gateway
52—Input Module
54—Camera Feed
56—Exemplary “Record” Button
57—Exemplary “Pause” Button
58—Exemplary “Stop” Button
60—Exemplary “Preview” Button
62—Exemplary “Crop” Button
64—Exemplary “Play” Button
66—Keyboard
68—IM App Icon
70—Exemplary “Attach” Icon
72—Input Video

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Embodiments of the present invention are directed to a computer-implemented system and method for creating, storing and sharing cropped multimedia content devoid of visual background information. More particularly, the cropped multimedia content refers to any and all real world subjects. To avoid confusion when referring to multiple real world subjects; human heads will be the primary use to further explain the present invention. Each human headshot and/or talking head comprises a video of the head of a human subject without background. The headshot video is preferably a short video, the duration of which ranges from 5 to 7 seconds. The headshot video may or may not be accompanied by sound, as at times, the video could just be a video conveying one or more facial expressions of the human subject therein. However, what further distinguishes the present invention from the prior art of emojis is the ability to create a talking head video with audio. In a way, a headshot video could be seen as a personalized emoticon with the face of the user (i.e., the human subject) featured in the headshot video. Embodiments of the present invention have one or more Instant Messaging (IM) or texting computer applications (apps) playing a part in the sharing of the headshot videos between two or more user terminals running at least one common IM app. The IM apps may comprise commonplace third-party IM apps such as Whatsapp, Viber, Skype, etc., or maybe be a native or proprietary IM app built into the operating system running on the user terminal. Outside of users utilizing third-party commonplace IM apps, MMS and SMS text messaging are default selections for users to connect and communicate with friends and family in the most unique way.

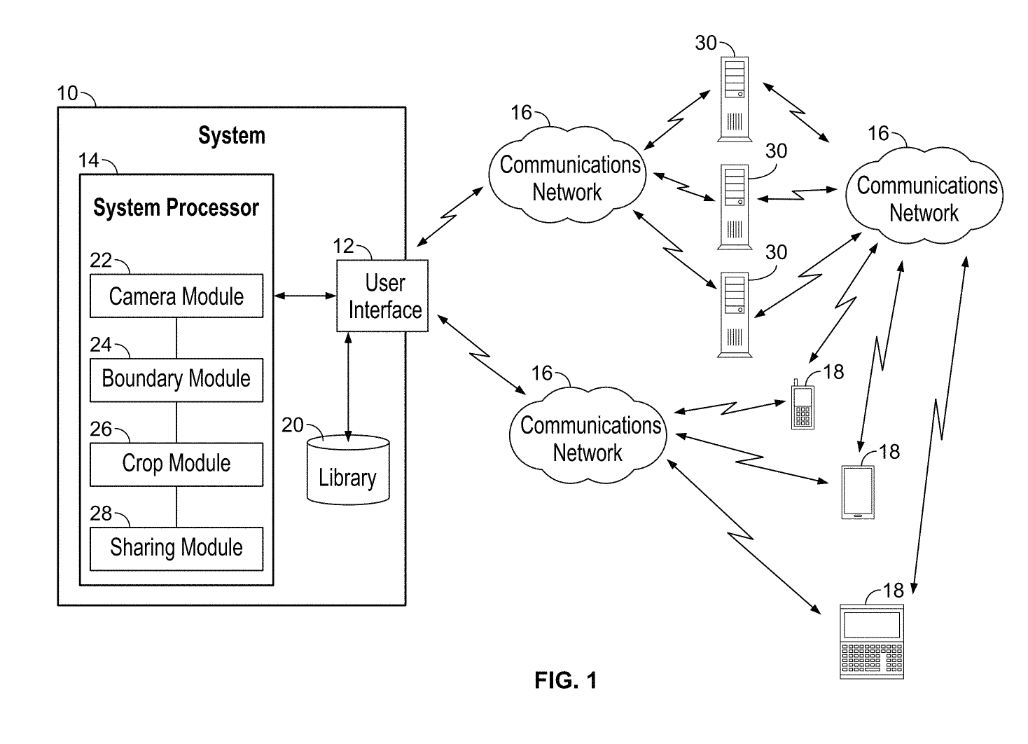

Referring to FIG. 1, the preferred embodiment of the system 10 of the present invention comprises a user interface 12 for enabling a user to interact therewith, a system processor 14, for ease of understanding, divided into a plurality of processing modules, and a library 20 for storing headshot videos. The user interface 12 is facilitated by a user terminal 18, which may comprise a smartphone, a tablet PC, a laptop PC, a desktop PC, etc., which has a video camera preferably built thereinto. The user interface 12 with the system 10 is facilitated by the user terminal 18 over a communications network 16 such as, the Internet, a Local Area Network (LAN) or the like. The system 10 is preferably meant to be downloaded as app on a smartphone or a laptop.

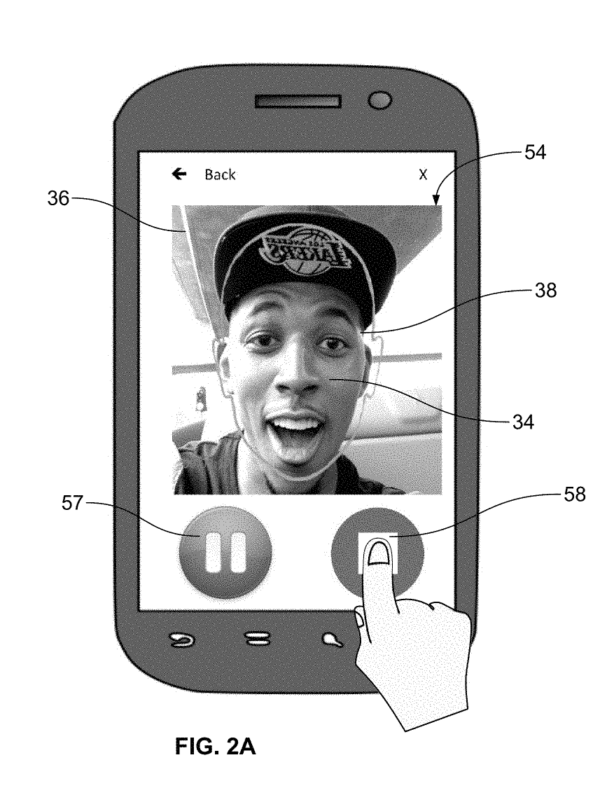

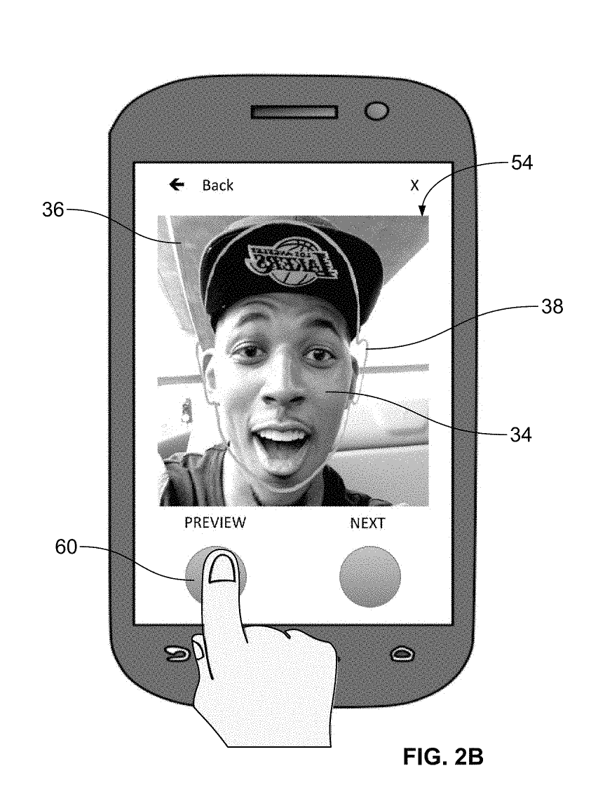

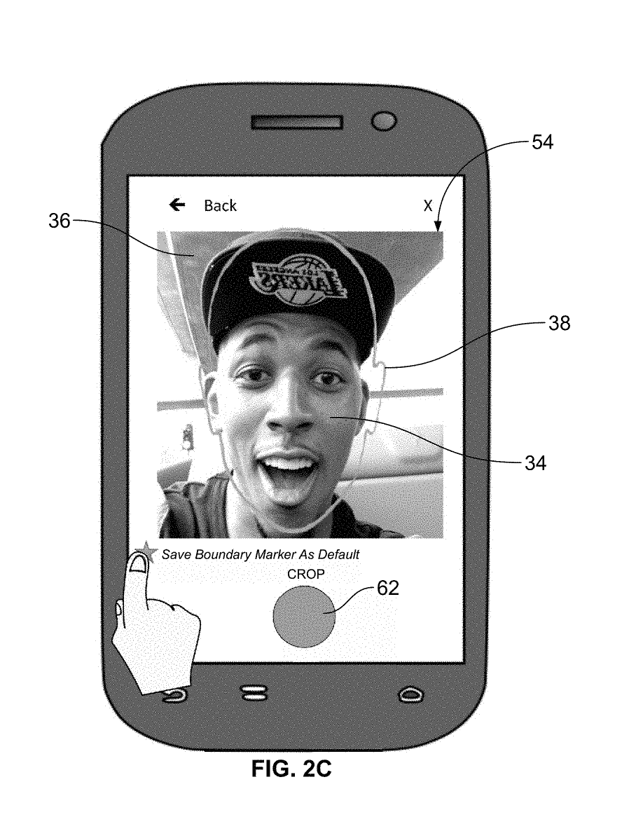

Referring to FIGS. 1, 2A, 3 and 7, the plurality of processing modules comprises a camera module 22, a boundary module 24, a crop module 26 and a sharing module 28. The camera module 22 is disposed in operative communication with the camera onboard the user terminal 18. The camera module 22 comprises an exemplary “Start” radio button (not shown), which when, via the user interface 12, is actuated, the camera is activated resulting in the display of the camera feed 54 on the display screen of the user terminal 18. As can be appreciated from FIGS. 1, 2A, 3, 7, 8A and 8B, the camera module 22 further comprises commonplace camera control radio buttons such as record 56, pause 57, stop 58, camera flip, etc., accessible via the user interface 12. The boundary module 24, which is disposed in operative communication with the camera module 22, comprises a boundary marker 38 overlaid on the camera feed 54. The boundary marker 38, as can be appreciated from FIGS. 1, 3, 7, 8A and 8B, comprises a closed curved outline, which is configured to be adjustable and movable via the user interface 12 until the boundary marker 38 is aligned with the boundaries of the head 34 of the human subject. In one embodiment, the boundary module 24 imbibes techniques from facial recognition, artificial intelligence and machine technology to detect the face, hair, eyes, chin, etc., of the human subject. This is so that the boundary marker 38 is, upon the initiation of the system 10 overlaid as close as possible to the boundary of the head 34 thereby minimizing user-adjustments to the boundary marker 38.

Referring to FIGS. 1, 2A, 2B, 3, 7 and 8A, once the boundary marker 38 is set to user's satisfaction, actuating, via the user interface 12, an exemplary “Record” button 62 results in the initiation of the recording of an input video. Notably, once the boundary marker 38 is set, the boundary marker 38 stays with the head 34 through the various movements thereof during the shoot. During the shoot, the user, as enabled by the camera module 22, may pause the shoot by actuating an exemplary “Pause” button 57. Once the video-recording is completed either by the actuation of an exemplary “Stop” button 58 or by running out of the time limit preset for the headshot video, the user is enabled to preview his or her recording by actuating an exemplary “Preview” button 60. Notably, during the preview, the position of the boundary marker 38 is locked with respect to the head 34. If the user is not satisfied with the outcome of the video recording, he or she may go back to re-shooting the input video by following the aforementioned process (as depicted by FIGS. 1, 2A, 2B, 3, 7, and 8A) by either actuating an exemplary “back” button or by deleting the video.

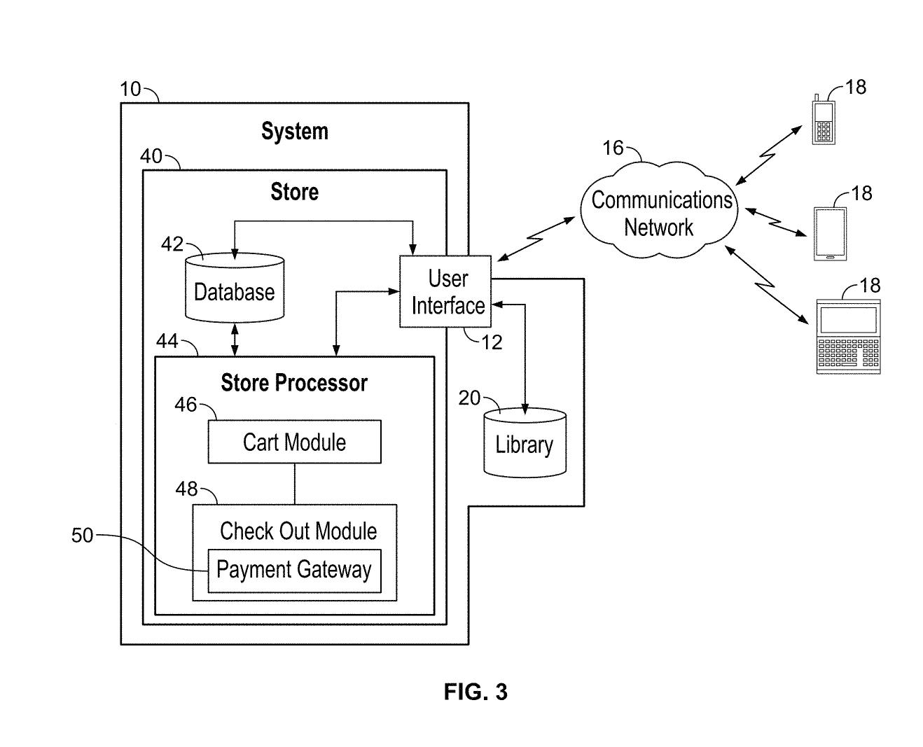

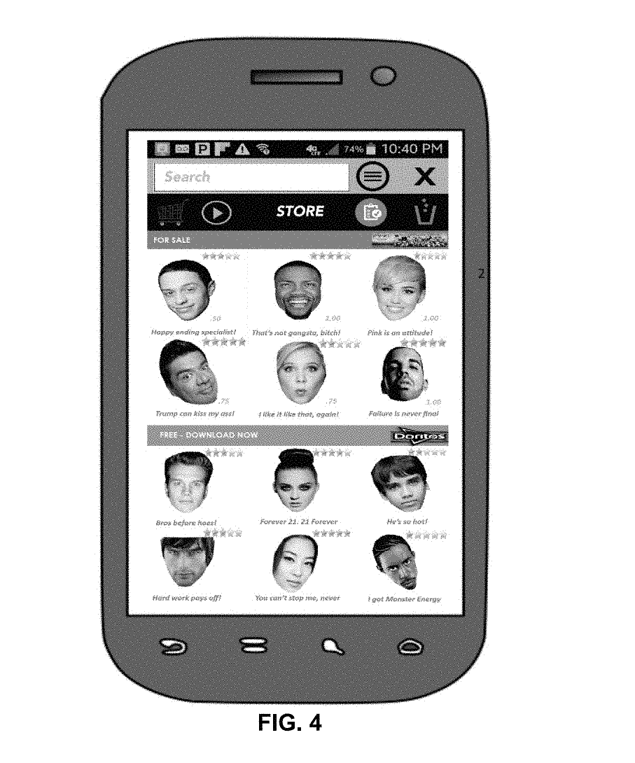

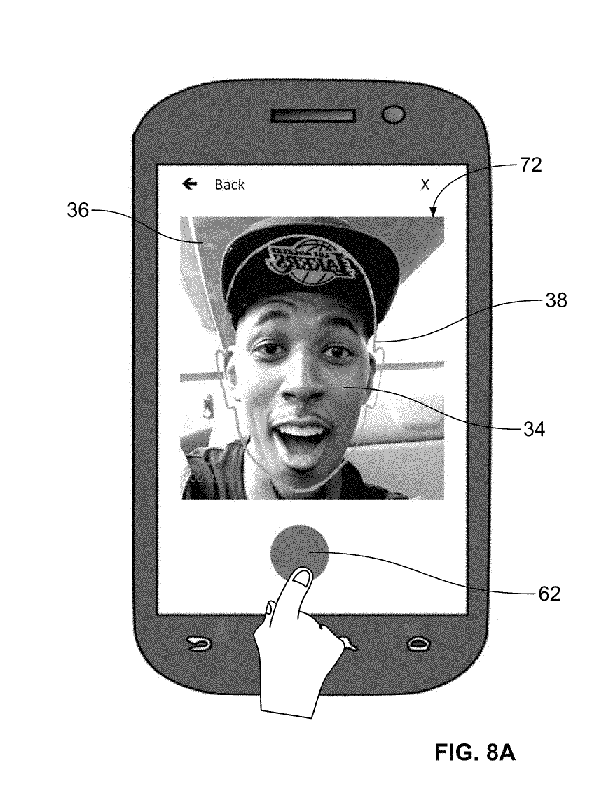

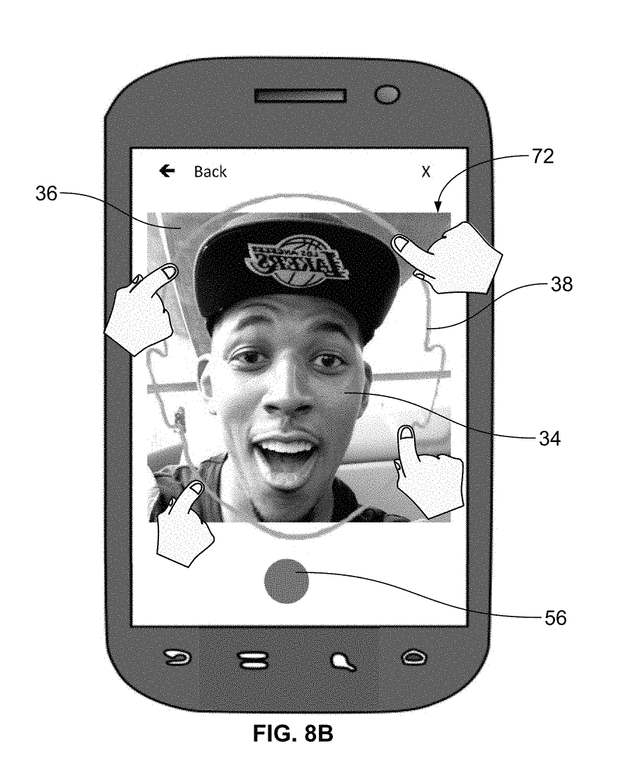

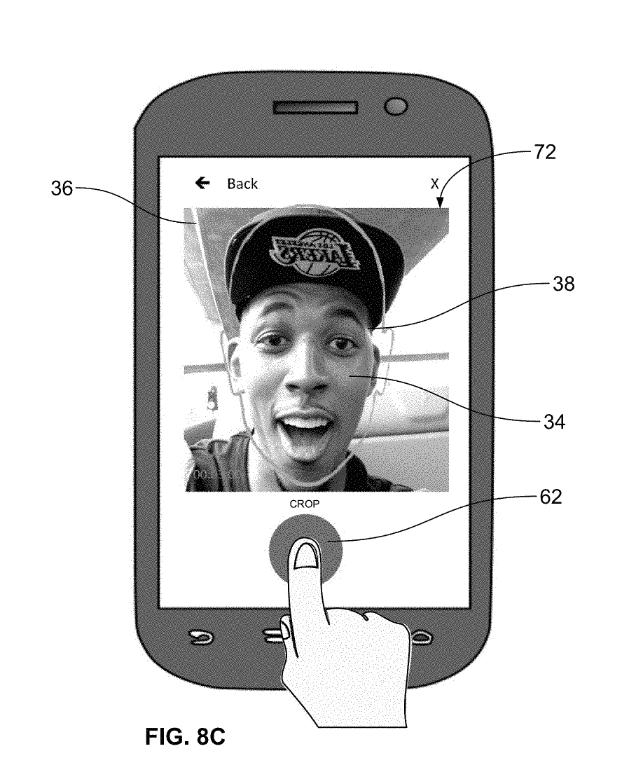

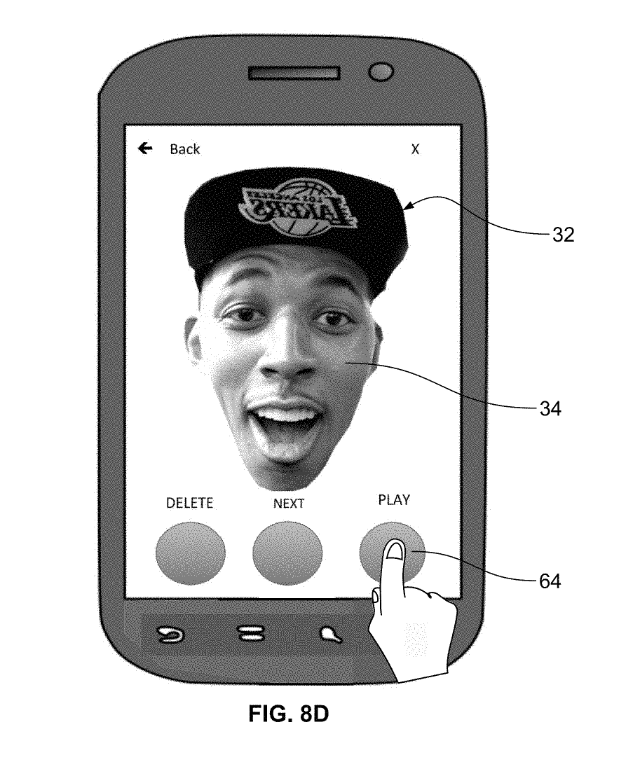

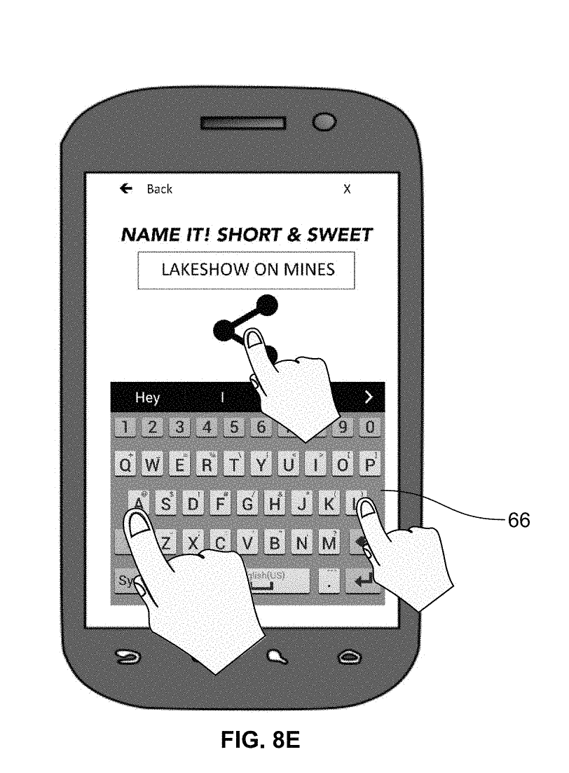

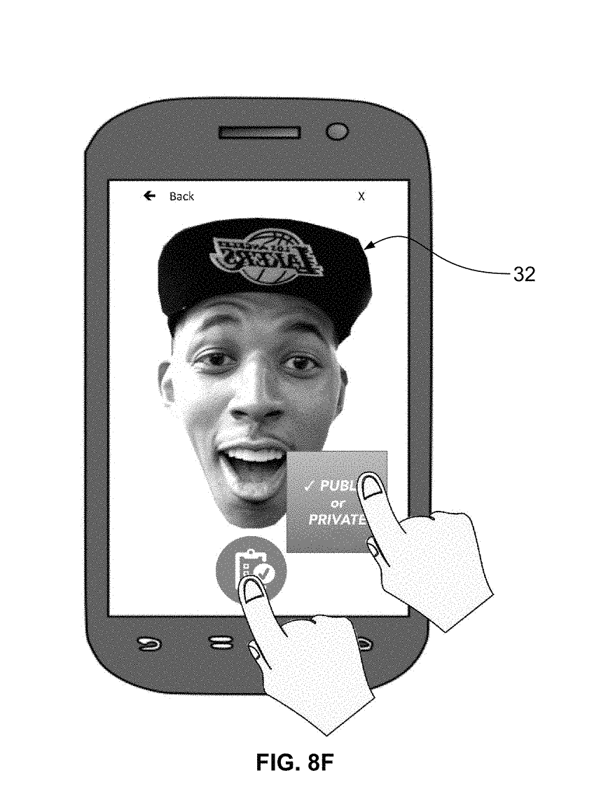

Referring to FIGS. 1, 8C and 8D on the other hand, if the user decides to go ahead, an exemplary “Crop” button 62 is provided by the crop module 26 wherein, when said “Crop” button 62 is actuated, the input video is processed by the crop module 26 resulting in saving the portion of the input video within the boundary marker 38 (i.e., the head 34 of the human subject) and omitting the rest of the video (i.e., the background 36) lying outside of the boundary marker 38. This results in the generation of a headshot video 32. In one embodiment, as can be appreciated particularly from FIGS. 1, 2C, 3, 7, 8C, 8D, 8E and 8F, the boundary module 24 comprises an exemplary “Save the Boundary Marker as Default” option. When said “Save the Boundary Marker as Default” option, via the user interface 12, is selected, the dimensions (i.e., the shape and size) of the boundary marker 38 are locked whereby, the user need not have to adjust the boundary marker 38 every time a headshot video is shot with the same human subject. However, notably, in this embodiment, the boundary marker 38 needs to be moved over the display screen of the user terminal 18 in order to be aligned with the boundary of the head 34 though. Once the headshot video 32 is generated, the user, as enabled by the camera module 22, may play or preview the same by selecting an exemplary “Play” button 64. As can be appreciated from FIG. 8E, the user is further prompted to title the headshot video 32 before being stored within the library 20. In one embodiment, as can be appreciated from FIGS. 1, 3, 8D, and 8F, before headshot video 32 being stored in the library 20, the user is prompted choose whether or not to give the headshot video 32 a public access. If the user chooses to make the headshot video 32 public, an exemplary “Public” option (such as, a checkbox or the like) is provided wherein, selecting the “Public” option enables fellow users to access the headshot video 32 from a store 40 (FIGS. 3 and 4), which will be explained in detail in the following body of text. On the other hand, if the user chooses the headshot video 32 to be private, an exemplary “Private” option (such as, a checkbox or the like) is provided wherein, selecting the “Private” option saves the headshot video 32 directly into the library 20.

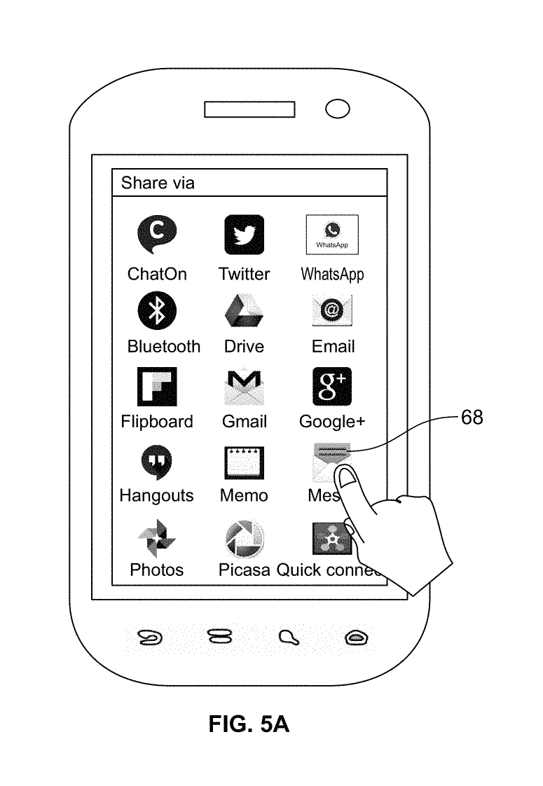

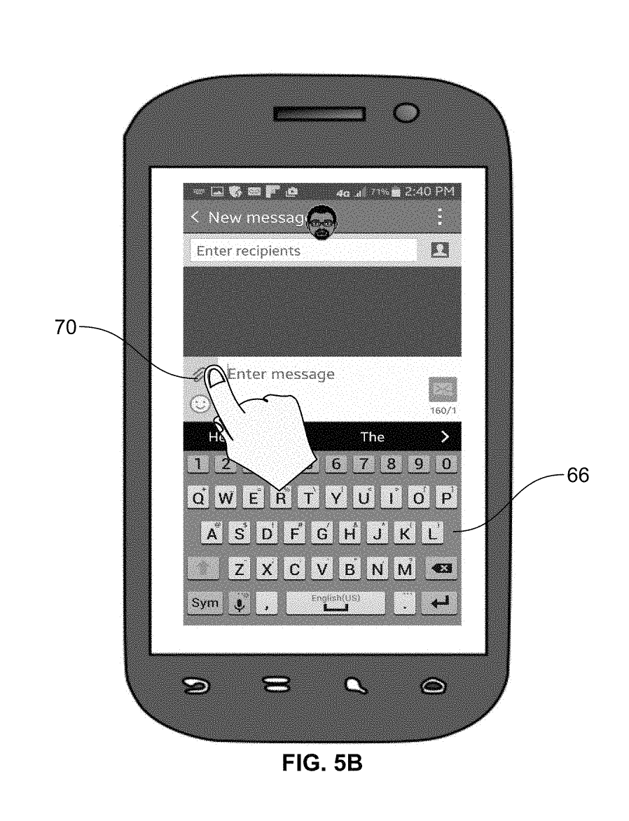

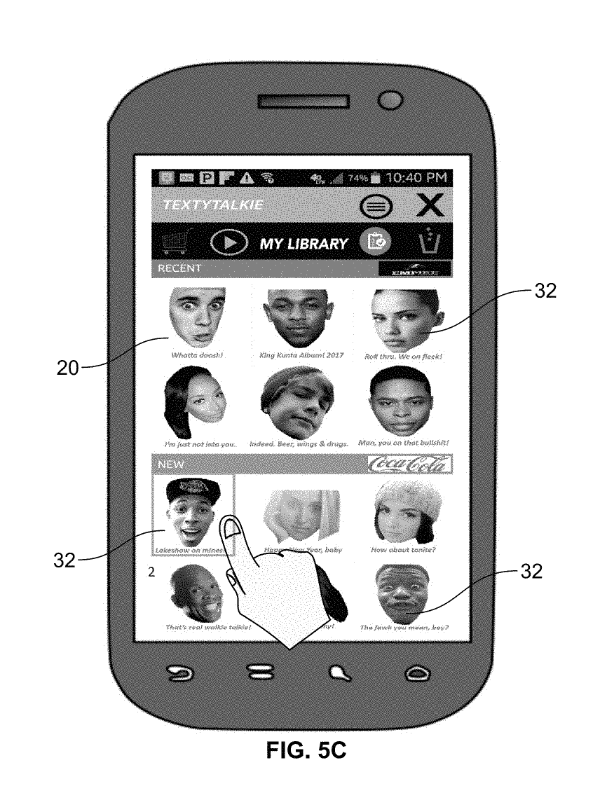

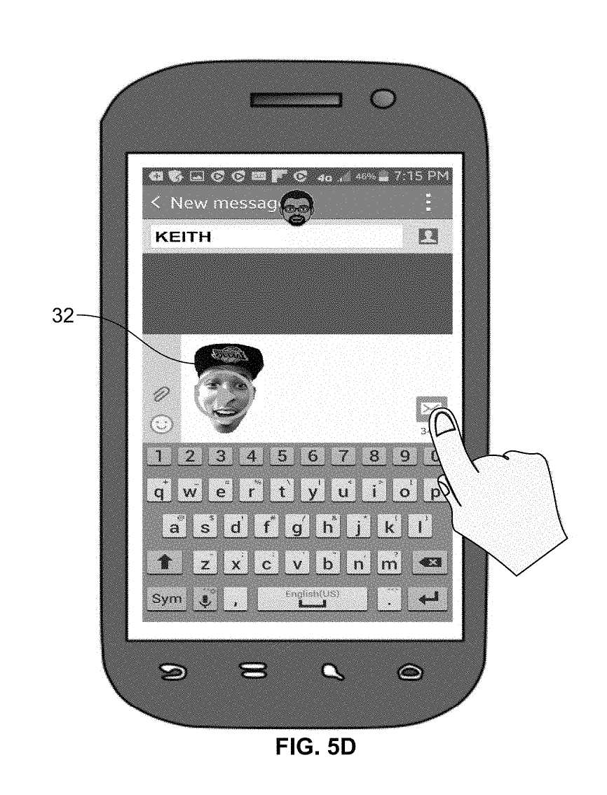

Referring to FIGS. 1 and 5C, the library 20 comprises a database listed with a plurality of headshot videos 32, which are either generated or downloaded by the user. The downloaded headshot videos 32 are categorized into free and paid headshot videos 32 wherein, both free and paid headshot videos are sourced from the store 40 (FIGS. 3 and 4).

Referring to FIGS. 3 and 4, the store 40, which is a part of the system 10, comprises a database 42 and store processor 44, which is divided into a cart module 46 and a checkout module 48. The store database 42 is listed with the plurality of headshot videos 32, which, as mentioned earlier, are categorized into free and paid headshot videos 32. Within the database 42, each paid headshot video 32 is associated with a price. The headshot videos 32 listed within the database 42, as can be appreciated from FIG. 4, are accessible via the user interface 12. The cart module 46 comprises an exemplary “Add to Cart” button (not shown) associated with each paid headshot video 32. Selecting the “Add to Cart” button via the user interface 12 moves the corresponding paid headshot video 32 to a shopping cart (not shown). The checkout module 48 comprises an exemplary “Checkout” button (not shown) associated with the cart page (not shown). Selecting the “Checkout” button on the cart page activates a payment gateway 50, which in turn moves the user to a checkout page (not shown) and prompts him or her to input his or her payment details. Upon the payment gateway 50 validating the payment details and processing the same, the purchased headshot videos 32 are moved into the library 20. The checkout module 48 further comprises an exemplary “Buy” button (not shown) associated with each paid headshot video 32 in the store 40 wherein, selecting the “Buy” button moves corresponding headshot video 32 into the cart and the user to the cart page directly. Selecting the “Checkout” button on the cart page activates the payment gateway 50, which in turn moves the user to a checkout page and prompts him or her to input his or her payment details. Upon the payment gateway 50 validating and processing the payment details, the purchased headshot video 32 is moved into the library 20. The checkout module further comprises an exemplary “Download” button (not shown) associated with each free headshot video 32 in the store 40. Selecting the “Download” button downloads the corresponding free headshot video 32 into the library 20.

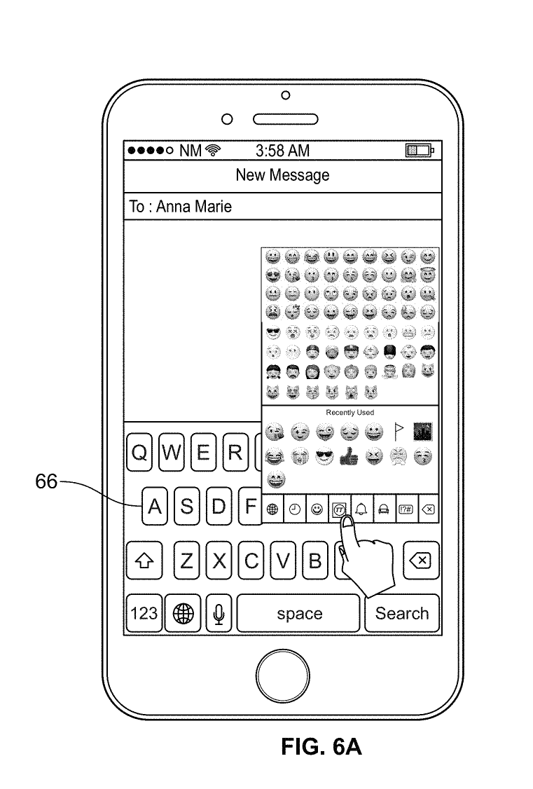

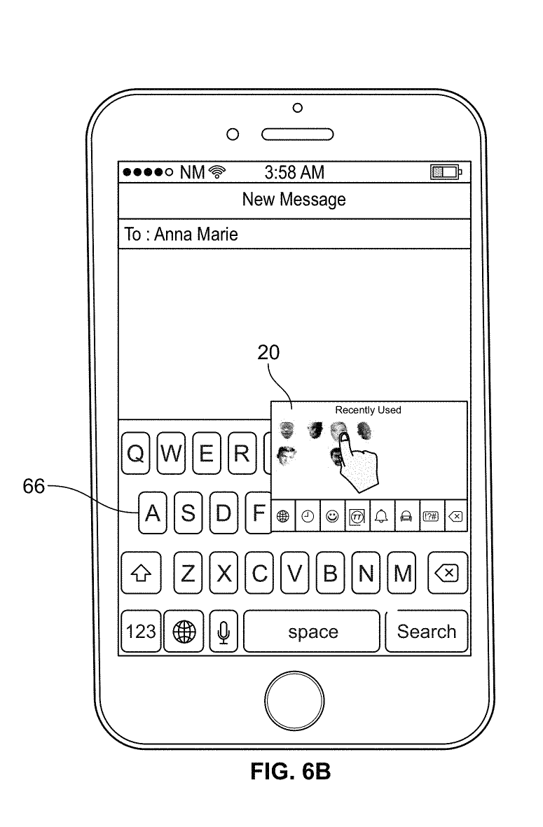

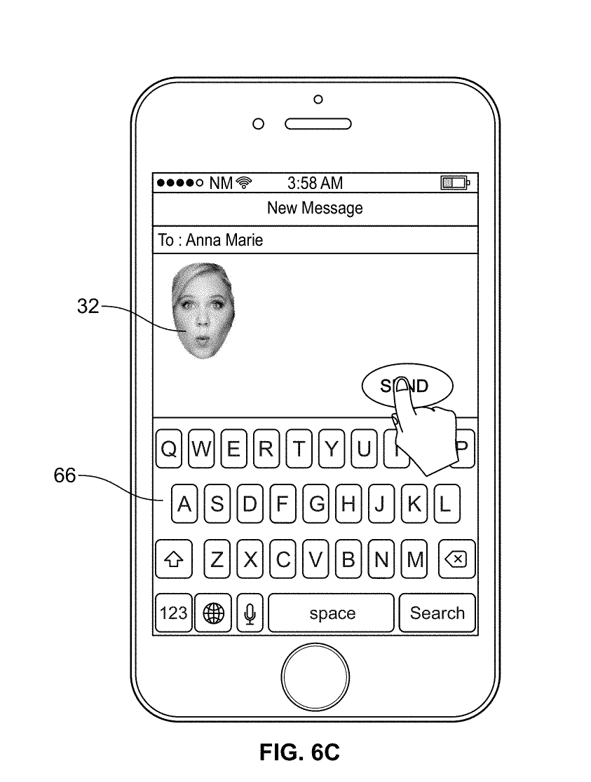

Referring to FIGS. 1, 4 and 5A through 5D, the sharing module 28, as mentioned earlier, establishes an operative communication between one or more IM app servers 30 and the system 10 via the user interface 12. As a result of the operative communication between the system 10 and the IM app servers 30, the headshot videos 32 stored within the library 20 can be shared between two or more user terminals 18 running at least one common IM app. As mentioned earlier, the IM app could be a third-party app such as, Whatsapp, Skype, or the like, or an IM app native to the operative system running on the user terminal 18. To share one's headshot video is not limited to share 32 with a fellow user (having a user terminal 18 running a common IM app), the user, as seen in FIG. 5A, simply needs to go the IM app by selecting the IM app icon 68. Once in the IM app, selecting an exemplary “Attach” icon 70 opens up an interface, which allows access to all the headshot videos 32 user-generated and downloaded stored within the library 20. The user may proceed to select one or more headshot videos 32, which then, upon inputting the recipient or recipients (by accessing contacts or by entering the recipient's name or number within a recipient input field), are dispatched to the user terminal of the recipient(s). In one embodiment, as can be appreciated from FIGS. 6A through 6C, the keyboard 66 built into the operating system itself is disposed in operative communication with the library 20. Notably, usually, the keyboard 66 is common to all the IM apps installed on the user terminal 18. The user, upon selecting an exemplary “Attach” icon (not shown) integrated into the keyboard 66, is granted access to the headshot videos 32 stored in the library 20 as seen particularly FIG. 6B. Once a headshot video 32 is selected and the recipient contact inputted, the selected headshot video 32 is dispatched to the recipient by actuating an exemplary “Send” button (FIG. 6C). In one embodiment, each headshot video 32 is associated with content wherein, upon sharing a headshot video 32 from an IM app, the content associated with the headshot video 32 is automatically and simultaneously shared with the recipient. More particularly, the content comprises a URL, the selection of which may direct the user to a landing page, which may be a sponsored advertisement, etc.

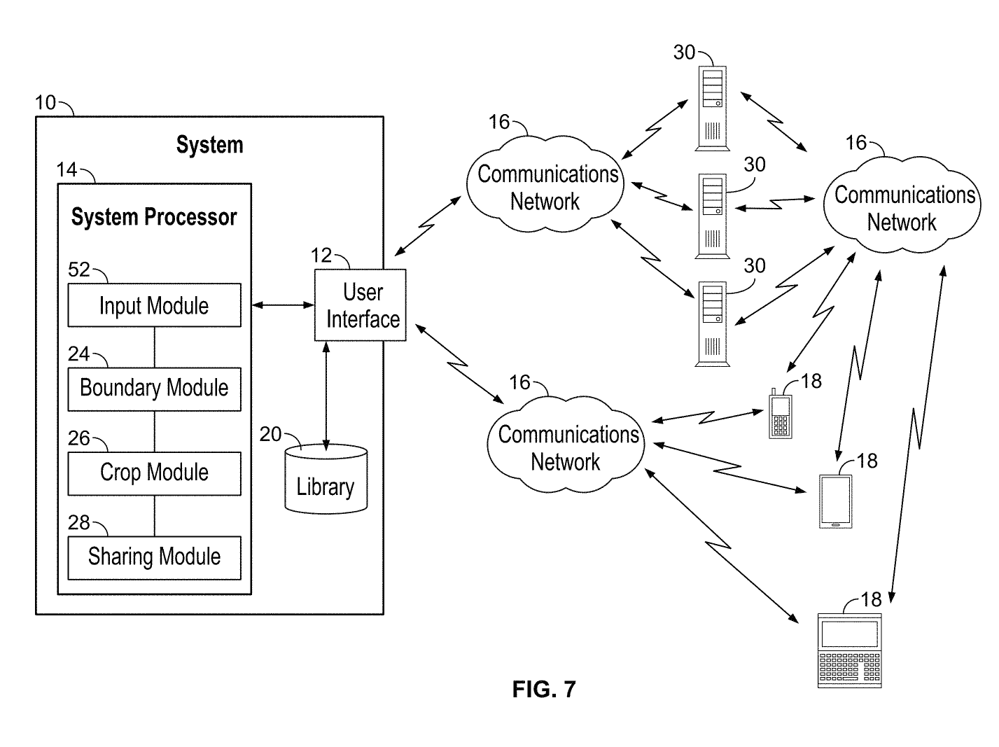

Referring to FIG. 7, an alternative embodiment of the system 10 of the present invention comprises a user interface 12 for enabling a user to interact therewith, a system processor 14, for ease of understanding, divided into a plurality of processing modules, and a library 20 for storing headshot videos. The user interface 12 is facilitated by a user terminal 18, which may comprise a smartphone, a tablet PC, a laptop PC, a desktop PC, etc., which has a video camera preferably built thereinto. The user interface 12 with the system 10 is facilitated by the user terminal 18 over a communications network 16 such as, the Internet, a Local Area Network (LAN) or the like.

Referring to FIGS. 7 and 8A through 8E, the plurality of processing modules comprises an input module 52, a boundary module 24, a crop module 26 and a sharing module 28. The input module 52 is disposed in operative communication with a video gallery (or galleries) installed on the user terminal 18. More particularly, the video gallery, as the name suggests, comprises a collection of videos that are either stored locally within the user terminal 18 or accessible from a cloud storage over the communications network 16. The video gallery may comprise a native or proprietary application or a third-party application. As can be appreciated from FIGS. 8A and 8B, each input video 72 features the head 34 or face of a human subject in a background 36. The input module 52 comprises an exemplary “Start” radio button (not shown), which when, via the user interface 12, is actuated, the videos within the video gallery are made accessible. Selecting a video from the video gallery results in rendering said input video 72 on the display screen of the user terminal 18. The boundary module 24, which is disposed in operative communication with the input module 52, comprises a boundary marker 38 overlaid on the input video 72 (FIGS. 8A and 8B). The boundary marker 38, as can be appreciated from FIGS. 8A and 8B, comprises a closed curved outline, which is configured to be adjustable and movable via the user interface 12 until the boundary marker 38 is aligned with the boundaries of the head 34 of the human subject as seen in FIG. 8B. Notably, once the boundary marker 38 is set, the boundary marker 38 is configured to stay with the head 34 through various movements thereof during the play of the input video 72. In one embodiment, the boundary module 24 imbibes techniques from facial recognition, artificial intelligence and machine technology to detect the face, hair, eyes, chin, etc., of the human subject. This is so that the boundary marker 38 is, upon the initiation of the system 10 overlaid as close as possible to the boundary of the head 34 thereby minimizing user-adjustments to the boundary marker 38.

Referring to FIGS. 8A through 8E, once the boundary marker 38 is set to user's satisfaction, actuating, via the user interface 12, an exemplary “Crop” button 62 results in saving the portion of the input video 72 within the boundary marker 38 (i.e., the head 34 of the human subject) and omitting the rest of the input video 72 (i.e., the background 36). This results in the generation of a headshot video 32. Once the headshot video 32 is generated, the user, as enabled by the input module 52, may play or preview the same by selecting an exemplary “Play” button 64 as seen in FIG. 8C. As can be appreciated from FIG. 8D, the user is further prompted to title the headshot video 32 before being stored within the library 20. In one embodiment, as can be appreciated from FIG. 8E, before headshot video 32 being stored in the library 20, the user is prompted choose whether or not to give the headshot video 32 a public access. If the user chooses to make the headshot video 32 public, an exemplary “Public” option (such as, a checkbox or the like) is provided wherein, selecting the “Public” option enables fellow users to access the headshot video 32 from the store 40 (FIGS. 3 and 4), which is same as the one discussed in the preferred embodiment of the present invention. On the other hand, if the user chooses the headshot video 32 to be private, an exemplary “Private” option (such as, a checkbox or the like) is provided wherein, selecting the “Private” option saves the headshot video 32 directly into the library 20, which, as discussed in the preferred embodiment of the system 10, comprises a database listed with a plurality of headshot videos 32, which are either generated or downloaded by the user.

Referring to FIGS. 4, 5A through 5D and 7 the sharing module 28, as mentioned earlier, establishes an operative communication between one or more IM app servers 30 and the system 10 via the user interface 12. As a result of the operative communication between the system 10 and the IM app servers 30, the headshot videos 32 stored within the library 20 are fit to be shared between two or more user terminals 18 running at least one common IM app. As mentioned earlier, the IM app could be a third-party app such as, WhatsApp, Skype, or the like, or an IM app native to the operating system running on the user terminal 18. One example a user can share a headshot video 32 with a fellow user (having a user terminal 18 running a common IM app), the user, as seen in FIG. 5A, simply needs to access the IM app by selecting the IM app icon 68. Once in the IM app, selecting an exemplary “Attach” icon 70 opens up an interface, which allows access to all the headshot videos 32 user-generated and downloaded stored within the library 20. The user may proceed to select one or more headshot videos 32, which then, upon inputting the recipient or recipients (by accessing contacts or by entering the recipient's name or number within a recipient input field), are dispatched to the user terminal 18 of the recipient(s). In one embodiment, as can be appreciated from FIGS. 6A through 6C, the keyboard 66 built into the operating system itself is disposed in operative communication with the library 20. Notably, usually, the keyboard 66 is common to all the IM apps installed on the user terminal 18. The user, upon selecting an exemplary “Attach” icon (not shown) integrated into the keyboard 66, is granted access to the headshot videos 32 stored in the library 20 as seen particularly FIG. 6B. Once a headshot video 32 is selected and the recipient contact inputted, the selected headshot video 32 is dispatched to the recipient by actuating an exemplary “Send” button (FIG. 6C). In one embodiment, each headshot video 32 is associated with content wherein, upon sharing a headshot video 32 from an IM app, the content associated with the headshot video 32 is automatically and simultaneously shared with the recipient. More particularly, the content comprises a URL, the selection of which may direct the user to a landing page, which may be a sponsored advertisement, etc.

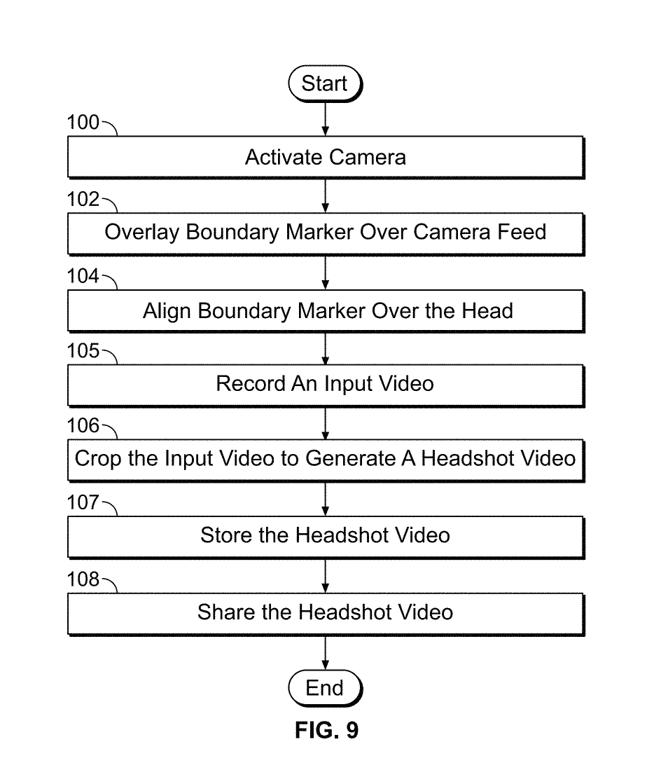

Referring to FIG. 9, a preferred embodiment of the computer-implemented method of the present invention initiates with activating (step 100) a video camera disposed in operative communication with a user terminal. The activation of the camera is in response to the reception of an electronic signal via a user interface wherein, the electronic signal initiates the camera. The user interface is facilitated by a user terminal, which may comprise a smartphone, a tablet PC, a laptop PC, a desktop PC, etc., which has the camera built thereinto. The user interface is facilitated over a communications network such as, the Internet, a Local Area Network (LAN) or the like.

Referring to FIG. 9, as a result of the activation of the camera, the camera feed is displayed on the display screen of the user terminal. As the headshot video is a product of the recording a portion or the entirety of the camera feed, the camera feed must feature the head of the human subject. The method further includes overlaying (step 102) a boundary marker over the camera feed. The boundary marker comprises a closed curved outline, which is configured to be adjustable and movable via the user interface until the boundary marker is aligned (step 104) with the boundaries of the head of the human subject. In one embodiment, the boundary module imbibes techniques from facial recognition, artificial intelligence and machine technology to detect the face, hair, eyes, chin, etc., of the human subject. This is so that the boundary marker is overlaid as close as possible to the boundary of the head thereby minimizing user-adjustments thereto.

Referring to FIG. 9, once the boundary marker is aligned (step 104) with the head, the method further includes initiating the recording (step 105) of an input video. Notably, once the boundary marker is set, the boundary marker stays with the head through the various movements thereof during the shoot. The method further includes pausing the shoot during the shoot by actuating an exemplary “Pause” button via the user interface. The method further includes completing the video-recording either by the actuation of an exemplary “Stop” button via the user interface or by running out of the time limit preset for the headshot video. The method further includes previewing his or her recording by actuating an exemplary “Preview” button via the user interface. Notably, during the preview, the position of the boundary marker is locked with respect to the head. If the user is not satisfied with the outcome of the video recording, he or she may go back to re-shooting the input video by following the aforementioned process by either actuating, via the user interface, an exemplary “back” button or by deleting the video.

Referring to FIG. 9, on the other hand, if the user decides to go ahead, the method includes cropping (step 106) the input video in response to the actuation of an exemplary “Crop” button via the user interface. Cropping (step 106) the video results in saving the portion of the input video within the boundary marker (i.e., the head of the human subject) and omitting the rest of the input video (i.e., the background) lying outside of the boundary marker. This results in the generation of a headshot video. In one embodiment, the method further includes locking the boundary marker by actuating an exemplary “Save the Boundary Marker as Default” option via the user interface. The “Save the Boundary Marker as Default” option, via the user interface, is actuated, the dimensions (i.e., the shape and size) of the boundary marker are locked whereby, the user need not have to adjust the boundary marker every time a headshot video is shot with the same human subject. However, notably, in this embodiment, the method still includes moving, via the user interface, the boundary marker over the display screen of the user terminal in order to be aligned with the boundary of the head though.

Referring to FIG. 9, the method further includes playing the headshot video upon the generation of the same by actuating an exemplary “Play” button via the user interface. The method further includes titling the headshot video by inputting the title through a keyboard. The method further includes storing (step 107) the headshot video within a library. In one embodiment, the method further includes deeming the headshot video public or private before being stored within the library. If the headshot video is chosen to be granted public access, the method further includes, by actuation of an exemplary “Public” option (such as, a checkbox or the like), simultaneously storing (i.e., uploading) the headshot video to a store, which will be explained in detail in the following body of text. On the other hand, if the headshot video is chosen be private, the method further includes storing (step 107) the headshot video to the library by actuation of an exemplary “Private” option (such as, a checkbox or the like). Notably, the library comprises a database listed with a plurality of headshot videos, which are either generated or downloaded by the user. The downloaded headshot videos are categorized into free and paid headshot videos wherein, both free and paid headshot videos are sourced (i.e., downloaded) from an online store.

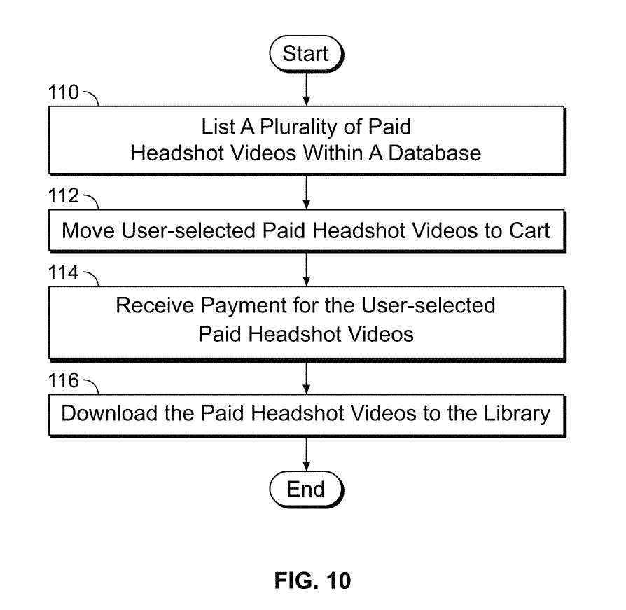

Referring to FIGS. 9 and 10, the method of the present invention further includes a sub-method of sourcing content (i.e., the headshot videos) from the store into the library. The sub-method initiates with listing (step 110) a plurality of headshot videos—both free and paid headshot videos—within a store database. Leaving the free headshot videos out for a while, each paid headshot video is associated with a price. The sub-method further comprises moving (step 112) a paid headshot video to an online shopping cart upon the actuation of an exemplary “Add to Cart” button associated therewith. The sub-method further comprises receiving (step 114), via the user interface, payment for the paid headshot video(s) that are within the cart by actuation of an exemplary “Checkout” button associated with the shopping cart page. Notably, the payment is received via a payment gateway, which, upon initial validation of the payment details, processes the same to remit payment. Upon remittance, the sub-method further includes downloading (step 116) the purchased headshot videos into the corresponding library. In case of free headshot videos, the sub-method includes downloading a free headshot video directly into the corresponding library upon the actuation of an exemplary “Download” button associated with said free headshot video.

Referring to FIG. 9, in order to share a headshot video, the method of sharing (step 108) further comprises accessing an IM app by selecting the corresponding IM app icon. Notably, the IM app is installed on the user terminal and is disposed in operative communication with the library. As mentioned earlier, the IM app could be a third-party app such as, WhatsApp, Skype, or the like, or an IM app native to the operating system running on the user terminal 18. The method further comprises accessing the library by selecting an exemplary “Attach” icon, which is part of the IM app. The method further comprises receiving a user-selection of one or more headshot videos from the library. The method then comprises receiving user-input of one or more recipients (by accessing contacts or by entering the recipient's name or number within a designated recipient input field). The method finally comprises sharing, by delivering, the user-selected one or more headshot videos to the one or more recipients by the actuation of an exemplary “Send” button. In one embodiment, the method further comprises associating each headshot video with content such that, upon sharing a headshot video from an IM app, the content associated with the headshot video is automatically and simultaneously shared with the recipient. More particularly, the content comprises a URL, the selection of which may direct the user to a landing page, which may be a sponsored advertisement, etc.

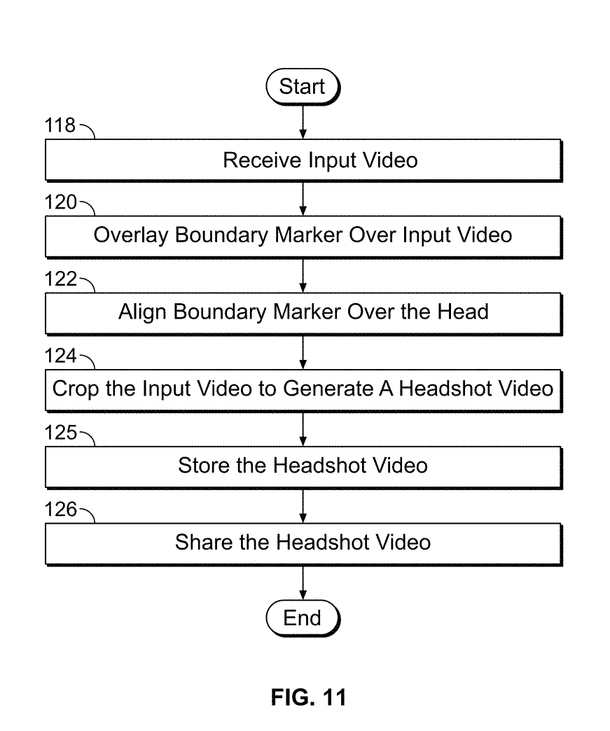

Referring to FIG. 11, an alternative embodiment of the computer-implemented method of the present invention initiates with receiving (step 118), via a user interface, an input video. The input video is sourced from a video gallery installed on a user terminal. More particularly, the video gallery comprises a collection of videos that are either stored locally within the user terminal or accessible from a cloud storage over the communications network. The video gallery may comprise a native or proprietary application or a third-party application. The user interface is facilitated by a user terminal such as, a smartphone, a tablet PC, a laptop PC, a desktop PC, or the like. The user interface is facilitated over a communications network such as, the Internet, a Local Area Network (LAN) or the like. Each input video features the head or face of a human subject in a background.

Referring to FIG. 11, the method further includes overlaying (step 120) a boundary marker over the input video. The boundary marker comprises a closed curved outline, which is configured to be adjustable and movable via the user interface until the boundary marker is aligned (step 122) with the boundaries of the head of the human subject. In one embodiment, the boundary module imbibes techniques from facial recognition, artificial intelligence and machine technology to detect the face, hair, eyes, chin, etc., of the human subject. This is so that the boundary marker is overlaid as close as possible to the boundary of the head thereby minimizing user-adjustments thereto.

Referring to FIG. 11, once the boundary marker is aligned (step 122) set, the boundary marker stays with the head through the various movements thereof during the duration of the input video. The method includes cropping (step 124) the input video in response to the actuation of an exemplary “Crop” button via the user interface. Cropping (step 124) the video results in saving the portion of the input video within the boundary marker (i.e., the head of the human subject) and omitting the rest of the input video (i.e., the background). This results in the generation of a headshot video.

Referring to FIG. 11, the method further includes playing the headshot video upon the generation of the same by actuating an exemplary “Play” button via the user interface. The method further includes titling the headshot video by inputting the title through a keyboard. The method further includes storing (step 125) the headshot video within a library. In one embodiment, the method further includes deeming the headshot video public or private before being stored within the library. If the headshot video is chosen to be granted public access, the method further includes, by actuation of an exemplary “Public” option (such as, a checkbox or the like), simultaneously storing (i.e., uploading) the headshot video to a store, which will be explained in detail in the following body of text. On the other hand, if the headshot video is chosen be private, the method further includes storing (step 125) the headshot video to the library by actuation of an exemplary “Private” option (such as, a checkbox or the like). Notably, the library comprises a database listed with a plurality of headshot videos, which are either generated or downloaded by the user. The downloaded headshot videos are categorized into free and paid headshot videos wherein, both free and paid headshot videos are sourced (i.e., downloaded) from an online store.

Referring to FIGS. 10 and 11, the method of the present invention further includes a sub-method of sourcing content (i.e., the headshot videos) from the store into the library. The sub-method initiates with listing (step 110) a plurality of headshot videos—both free and paid headshot videos—within a store database. Leaving the free headshot videos out for a while, each paid headshot video is associated with a price. The sub-method further comprises moving (step 112) a paid headshot video to an online shopping cart upon the actuation of an exemplary “Add to Cart” button associated therewith. The sub-method further comprises receiving (step 114), via the user interface, payment for the paid headshot video(s) that are within the cart by actuation of an exemplary “Checkout” button associated with the shopping cart page. Notably, the payment is received via a payment gateway, which, upon initial validation of the payment details, processes the same to remit payment. Upon remittance, the sub-method further includes downloading (step 116) the purchased headshot videos into the corresponding library. In case of free headshot videos, the sub-method includes downloading a free headshot video directly into the corresponding library upon the actuation of an exemplary “Download” button associated with said free headshot video.

Referring to FIG. 9, in order to share a headshot video, the method of sharing (step 126) further comprises accessing an IM app by selecting the corresponding IM app icon. Notably, the IM app is installed on the user terminal and is disposed in operative communication with the library. As mentioned earlier, the IM app could be a third-party app such as, WhatsApp, Skype, or the like, or an IM app native to the operative system running on the user terminal 18. The method further comprises accessing the library by selecting an exemplary “Attach” icon, which is part of the IM app. The method further comprises receiving a user-selection of one or more headshot videos from the library. The method then comprises receiving user-input of one or more recipients (by accessing contacts or by entering the recipient's name or number within a designated recipient input field). The method finally comprises sharing, by delivering, the user-selected one or more headshot videos to the one or more recipients by the actuation of an exemplary “Send” button. In one embodiment, the method further comprises associating each headshot video with content such that, upon sharing a headshot video from an IM app, the content associated with the headshot video is automatically and simultaneously shared with the recipient. More particularly, the content comprises a URL, the selection of which may direct the user to a landing page, which may be a sponsored advertisement, etc.

The aforementioned embodiments are able to be implemented, for example, using a machine-readable medium or article which is able to store an instruction or a set of instructions that, if executed by a machine, cause the machine to perform a method and or operations described herein. Such machine is able to include, for example, any suitable processing platform, computing platform, computing device, processing device, electronic device, electronic system, computing system, processing system, computer, processor, or the like, and is able to be implemented using any suitable combination of hardware and or software. The machine-readable medium or article is able to include, for example, any suitable type of memory section, memory device, memory article, memory medium, storage device, storage article, storage medium and or storage section; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and or interpreted programming language, e.g., C, C++, Java, BASIC, Pascal, Fortran, Cobol, assembly language, machine code, or the like. Functions, operations, components and or features described herein with reference to one or more embodiments, is able to be combined with, or is able to be utilized in combination with, one or more other functions, operations, components and or features described herein with reference to one or more other embodiments, or vice versa.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented system for creating, storing and sharing cropped videos, a cropped video comprises of real world subjects (i.e., talking head, birthday cake, full body) exclusive of visual background information, the system comprising:
(a) a user interface;
(b) a camera module for, via the user interface, activating a video camera and the controls associated therewith;
(c) a boundary module for overlaying a boundary marker over the camera feed, the boundary marker configured to be user-adjustable so as to, via the user interface, align the boundary marker with the boundaries of the head, the boundary marker, upon alignment, configured to stay with the head throughout the movements thereof as reflected in the camera feed, a portion or the entirety of which is recorded resulting in the generation of an input video;
(d) a crop module for cropping the input video so as to retain the head portion of the input video as defined by the boundary marker while leaving out the rest of the input video outside of the boundary marker resulting in the generation of the headshot video;
(e) a library for storing the headshot video therewithin upon the generation thereof; and
(f) a sharing module disposed in operative communication between the library and one or more communication applications (apps) so as to enable sharing of the headshot video from the one or more communication apps, including native text apps, as the headshot video is accessed from the library or instantly sent upon creation.

2. The system of claim 1 wherein, the cropped video comprises an audio track synchronized therewith.

3. The system of claim 1 wherein, the camera is disposed onboard a user terminal that facilitates the user interface.

4. The system of claim 3 wherein, the user terminal comprises one of a smartphone, a tablet PC, a desktop PC and a laptop PC.

5. The system of claim 1 further comprising a store disposed in operative communication with the library, the store comprising:
(a) a database comprising a plurality of paid headshot videos listed therewithin, each paid headshot video associated with the price thereof;
(b) a cart module for, via the user interface, enabling user-selection of one or more paid headshot videos;
(c) a checkout module for, via a payment module, receiving payment for the selected one or more paid cropped videos of real world subjects (i.e., talking head or headshot) thereby completing the purchase thereof;
wherein, the purchased one or more headshot videos are downloaded to the library wherefrom the purchased one or more headshot videos are fit to be shared from the one or more communication apps.

6. The system of claim 1 wherein, the camera controls include record, play, and pause radio buttons.

7. The system of claim 1 wherein, each headshot video is configured to be optionally associated with content; the associated content configured to be displayed along with the corresponding headshot video when the corresponding headshot video is received by the recipient or recipients, to whom the headshot video is sent from a communication app.

8. The system of claim 7 wherein, the associated content comprises a URL, which when selected, directs ad user to a landing page.

9. The system of claim 1 wherein, the communication app comprises a social networking app.

10. The system of claim 1 wherein, the communication app comprises an Instant Messaging (IM) app.

11. A computer-implemented system for creating, storing and sharing headshot videos, each of which comprising a cropped video of real world subjects (birthday cake, exotic car, talking head or headshot) subject exclusive of visual background information, the system comprising:
(a) a user interface;
(b) an input module for receiving an input video via the user interface, the input video comprising the head of the human subject;
(c) a boundary module for overlaying a boundary marker over the input video, the boundary marker configured to be user-adjustable so as to, via the user interface, align the boundary marker with the boundaries of the real world subject of choice (i.e. talking head), the boundary marker, upon alignment, configured to stay with the head throughout the movements thereof as reflected in the input video;
(d) a crop module for cropping the input video so as to retain the head portion of the input video as defined by the boundary marker while leaving out the rest of the input video lying outside of the boundary marker resulting in the generation of the headshot video;
(e) a library for storing the headshot video therewithin upon the generation thereof; and
(f) a sharing module disposed in operative communication between the library and one or more communication applications (apps) so as to enable sharing of the headshot video from the one or more communication apps as the headshot video is accessed from the library.

12. The system of claim 11 wherein, the cropped video comprises an audio track synchronized therewith.

13. The system of claim 11 wherein, the input video is sourced from cloud storage.

14. The system of claim 11 wherein, the input video is sourced from a local storage on a user terminal that facilitates the user interface.

15. The system of claim 14 wherein, the user terminal comprises one of a smartphone, a tablet PC, a desktop PC and a laptop PC.

16. The system of claim 11 further comprising a store disposed in operative communication with the library, the store comprising:
(a) a database comprising a plurality of headshot videos listed therewithin, each cropped (i.e., headshot or talking head) video associated with a price;
(b) a cart module for, via the user interface, enabling user-selection of one or more cropped (i.e., headshot) videos;
(c) a checkout module for, via a payment module, receiving payment for the selected one or more cropped (i.e., headshot) videos thereby completing the purchase of the one or more headshot videos;
wherein, the purchased of one or more cropped (i.e., headshot or talking head) videos are moved to the library wherefrom the purchased one or more headshot videos are fit to be shared.

17. The system of claim 11 wherein, each cropped (i.e., headshot or talking head) video is configured to be optionally associated with associated content; the associated content is configured to be displayed along with the corresponding cropped (i.e., headshot or talking head) video when the corresponding headshot video is shared via a communication app.

18. The system of claim 17 wherein, the associated content comprises a URL, which when selected, directs the user to a landing page.

19. The system of claim 11 wherein, the communication app comprises a social networking app.

20. The system of claim 11 wherein, the communication app comprises an Instant Messaging (IM) app.

21. A computer-implemented method for creating, storing and sharing cropped videos, a cropped video is a video of a real world subject (i.e., headshot, talking head videos, full human body, exotic car wheels, high heel shoes) exclusive of visual background information, the method comprising:
(a) providing a user interface;
(b) overlaying a boundary marker over an input video featuring the head of the human subject with a background, the boundary marker configured to be adjustable and movable;
(c) aligning the boundary marker with the boundaries of the head whereby, upon alignment, the boundary marker stays with the real world subject (i.e., head) throughout the movements in the input video;
(d) cropping the input video so as to retain the head portion of the input video as defined by the boundary marker while leaving out the rest of the input video lying outside of the boundary marker resulting in the generation of the headshot video;
(e) storing the cropped (i.e., headshot and talking head) video, upon the generation thereof, within a library; and
(f) a sharing the headshot video from one or more communication applications (apps).

22. The method of claim 21 wherein, the input video is generated from a video camera onboard a user terminal that provides the user interface.

23. The method of claim 21 wherein, the boundary marker is on the camera feed from the video camera prior to the recording of the input video.

24. The method of claim 21 wherein, the input video is sourced from cloud storage.

25. The method of claim 21 wherein, the input video is sourced from a local storage on a user terminal that facilitates the user interface.

26. The method of claim 25 wherein, the user terminal comprises one of a smartphone, a tablet PC, a desktop PC and a laptop PC.

27. The method of claim 21 further comprising:
(a) listing a plurality of paid cropped videos (i.e., headshot or talking head videos) listed within a database, each paid headshot video associated with the price thereof;
(b) receiving, via the user interface, user-selection of one or more paid headshot videos;
(c) via a payment module, receiving payment for the selected one or more paid headshot videos thereby completing the purchase thereof;
wherein, the purchased one or more headshot videos are downloaded to the library wherefrom the purchased one or more cropped (i.e., headshot or talking head videos) are fit to be shared from the one or more communication apps.

28. The method of claim 21 wherein, the cropped video (i.e., headshot or talking head) comprises an audio track synchronized therewith.

29. The method of claim 21 further comprising associating each headshot video with content so that associated content is displayed along with the corresponding headshot video when the corresponding headshot video is received by the recipient or recipients, to whom the headshot video is delivered from a communication app.

30. The method of claim 29 wherein, the associated content comprises a URL, which when selected, directs ad user to a landing page.

31. The method of claim 21 wherein, the IM app comprises a third-party app.

32. The system of claim 21 wherein, the communication app comprises a social networking app.

33. The system of claim 21 wherein, the communication app comprises an Instant Messaging (IM) app.
